(19) United States
(12) Patent Application Publication
(10) Pub. No.: US 2009/0094147 A1
(43) Pub. Date: Apr. 9, 2009

(54) Multi-Computer Data Transfer and Processing to Support Electronic Content Clearance and Licensing

(76) Inventors: Gene S. Fein, Lenox, MA (US); Edward Merritt, Lenox, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/869,438

(22) Filed: Oct. 9, 2007

(51) Int. Cl. G06Q 30/00

(52) U.S. Cl. 705/35; 705/1

(57) ABSTRACT

Multi-computer data transfer and processing supports electronic content clearance and licensing. Data is transferred by external communication between separate computers which themselves are distinguishable processing entities, such as a licensor station, a licensee station and a licensing system station accessible by a tiered access web site. Licensors submit content, and demonstrative content samples, searchable by licensees. Licenses, which may be generated and delivered electronically, may be granted or denied according to predetermined parameters or analysis of licensing requests. The system may be fee-based, advertising-based, membership fee-based, or may charge a royalty per transaction, and may collect and distribute licensing fees. License progress may be tracked. Licensed content may be delivered and tracked online, and confirmed by licensees by accountings. The system may track royalties based upon these uses, with payment reminders sent to licensees when payments are due, and default notices in the event of late or missed payments.

### BACKGROUND OF THE INVENTION

Various online systems allow users to obtain, via license or purchase, content such as video programming, music, still photography and art. For example, web sites, such as GettyImages.com (provided by Getty Images®, iTunes.com (providing access to the iTunes Music Store^{SM}), Movielink.com (provided by Movielink®), and eBay.com (provided by eBay®), allow licensing or purchasing of content, with delivery of that content via an online transaction. Conventional models address standardized agreements for content between users and content providers, bidding processes that may reward the highest bidder, or sometimes a mix of both the bidding process and the standardized price agreement, in the case of sites like eBay.com®.

Unfortunately, the existing conventional uses have limitations including flexibility, implementation, distribution and deployment. Standardized licenses for relatively narrow uses are the norm, with specialized and customized licensing rare or nonexistent. Further, because articles of content, such as music and film, frequently have numerous rights holders, the process of fully licensing an article of content can oftentimes mean striking a variety of contracts. This process can be expensive and time-consuming for all stakeholders even before it can be determined whether, in fact, the article of content may be licensed under the terms proposed by the licensor or the licensee, or open ended requests by either party that may warrant multiple rounds of communication and negotiation just to begin the licensing process.

### SUMMARY OF THE INVENTION

Example embodiments of the present invention relate to multi-computer data transfer and processing to support electronic content clearance and licensing. Data is transferred by external communication between separate computers which themselves are distinguishable processing entities, such as a licensor station, a licensee station and a licensing system station accessible by a tiered access web site enabling licensors to make content available to licensees for search and licensing.

Licensees submit a license request which is examined. Licenses may be granted or denied automatically according to default parameters established by licensors, as well as manually on a case by case analysis of a licensing request.

Content samples may be made available by content owners. The licensing system may collect licensing fees and distribute them to the proper parties. The licensing system may be fee-based, advertising-based, membership fee-based, or may charge a royalty per transaction. Licensors and licensees may track the progress of a license request via the system.

Licenses may be generated and delivered electronically or by traditional means. Similarly, licensed media may be delivered electronically or by traditional means. Reminders regarding license expiration, renewal or option periods may be sent to licensees and licensors. Royalty tracking may be available online via the system. Dispute resolution scenarios may also be available.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating licensing system that enables licensors to make articles of content available for licensing according to an example embodiment of the present invention.

FIG. 2 is a flow diagram illustrating an example interaction between a licensor station, a licensing system station, and a licensee station according to an example embodiment of the present invention.

FIG. 3 is a block diagram illustrating a screenshot of a License Request Form (LRF) that may be completed by users for submitting a license request to a licensing system in an example embodiments of the present invention.

FIG. 4 is a diagram illustrating the flow of content and license fees between a licensing system, a licensee station and a licensor station according to an example embodiment of the present invention.

FIG. 5 is a block diagram illustrating a screenshot of an analysis page enabling licensors and licensees to determine where their respective default parameters and requests for licensing fall within the market.

### DETAILED DESCRIPTION OF THE INVENTION

A description of example embodiments of the invention follows.

Currently there is no centralized online forum that enables the licensing of all elements relating to film, music, software, copyrights, trademarks and patents encompassing all elements of content licensing: search, offer, acceptance, contracting, fulfillment, renewal, cancellation, dispute resolution, reporting and royalty monitoring. Accordingly, there is a need for an integrated online content licensing system that enables the comprehensive needs of the licensing process for content relating to film, music, and other IP, such as software, patents, etc. in a single forum, with all elements of the content licensing process: search, offer, acceptance, contracting, fulfillment, security, renewal, cancellation, dispute resolution, reporting, database management, layered rights display capacity, and royalty monitoring of content all available in the system via an online format.

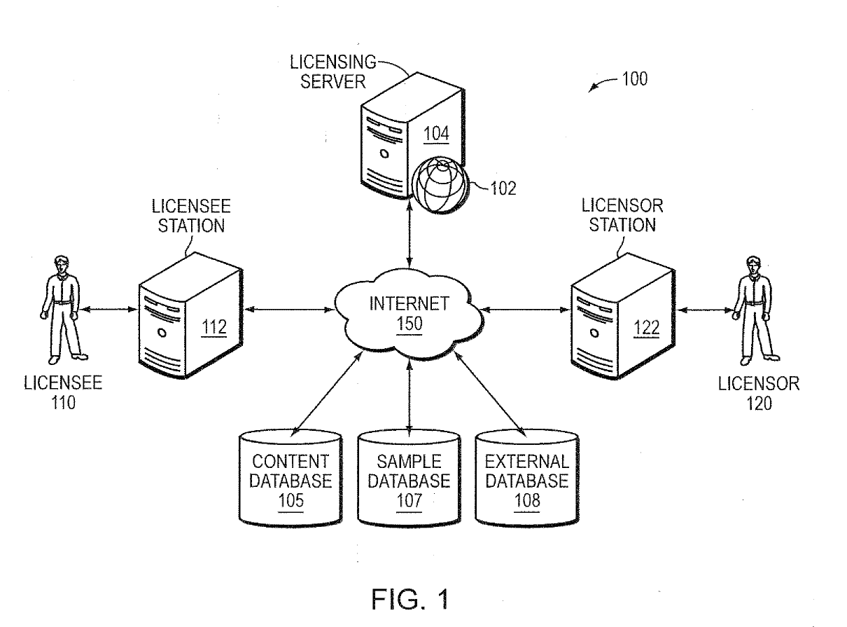

FIG. 1 illustrates an example embodiment of the present invention in which a licensing system 100 enables content providers (i.e., licensors 120 via a licensor station 122) to make articles of content available for licensing, while making those articles of content searchable by users (i.e., licensees 120 via a licensee station 112). The licensing system 100 enables the licensee 110 to perform all or part of the process of licensing content stored in the content database 105 as supplied by the licensor 120, such as by electronic submission through the licensor station 122 via a web interface 102. The web interface 102 may provide varying levels of service depending on access rights granted in the licensing server 104 to the parties, including the licensee 110 and the licensor 120. The licensing system 100 may be deployed either via the internet 150 or other broadband resource, Virtual Private Network (VPN), intranet, satellite, or any combination thereof.

Further, the licensor 120 similarly may submit samples of the articles of content to a samples database 107 through the licensor station 122 via the web interface 102 to the licensing server 104 for use by the licensee 110 in selecting articles of content for licensing. The samples also may be generated by the licensing server 104 following submission of an article of content to the content database 105.

At or after a time of submission of content to the content database 105, the licensor 120 may, through the licensor station 122 via the web interface 102 to the licensing server 104, set certain default parameters for the submitted articles of content. Such default parameters may include costs associated with particular licensing right (such as full rights and partial rights), territories available for licensing, license terms (i.e., length of the license) or other conditions of the license. Further, the licensor 120 may set terms for outright sale of the content, or copies thereof Moreover, the licensor 120 may delegate partial or total review and approval of licensing requests to other parties associated with the licensor 120, such as content rights holders, authors, artists and other content creators, which may be specified at this time.

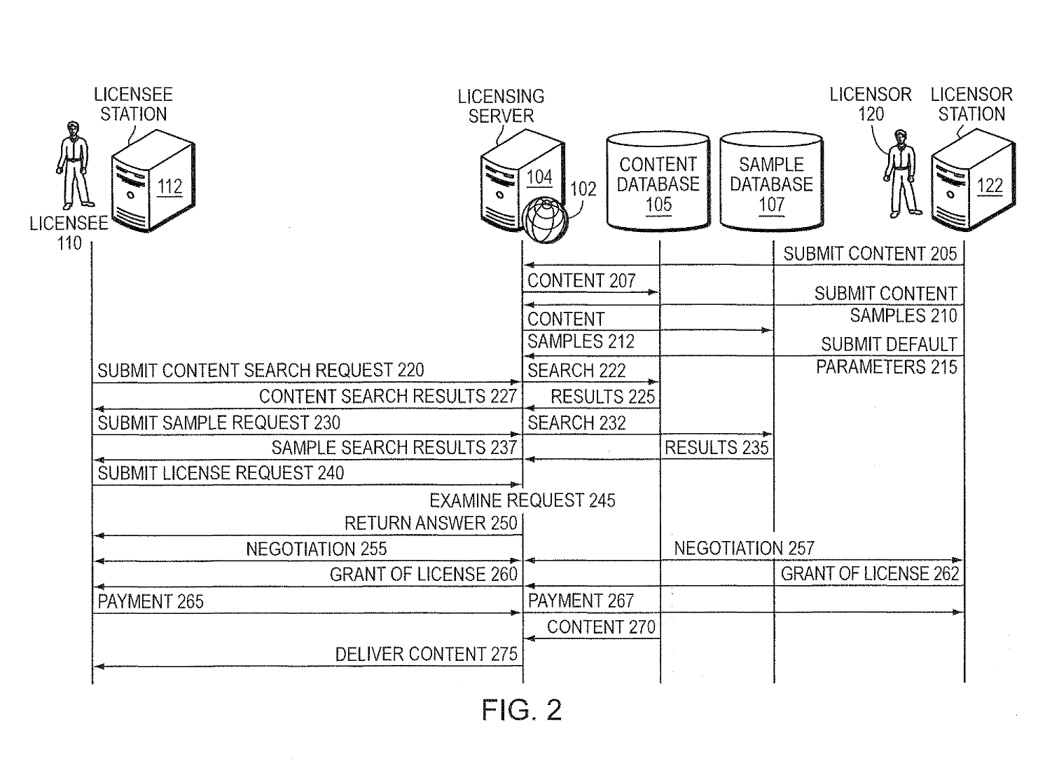

FIG. 2 is a flow diagram illustrating an example interaction between a licensor station (e.g., licensor station 122 of FIG. 1), a licensing server (e.g., licensing server 104 of FIG. 1), and a licensee station (e.g., licensee station 112 of FIG. 1) in an example embodiment of the present invention. First, a licensor (e.g., licensor 120 of FIG. 1) submits content at step 205, through the licensor station via a web interface (e.g., web interface 102 of FIG. 1) to the licensing server (e.g., licensing server 104 of FIG. 1), to the content database (e.g., content database 105 of FIG. 1). At this time, or a time after, the licensor similarly may supply content samples at step 210, through the licensor station via the web interface to the licensing server, to the sample database (e.g., sample database 107 of FIG. 1). Default licensing parameters also may be submitted at step 215 for assigning to the associated submitted content in the content database.

With content available in the content database and samples optionally available in the sample database, licensees (e.g., licensee 110 of FIG. 1) then may submit a search request at step 220, through the licensee station via the web interface to the licensing server, which will search the content database at step 222 for articles of content desired for licensing matching the licensee's search request. The content database will then return content results at step 225, if any, to the licensing server, made available at step 227 to the licensee through the licensee station via the web interface to the licensing server.

The licensee, similarly, then may submit a sample search request at step 230, through the licensee station via the web interface to the licensing server, which will search the sample database at step 232 for requested content samples. The samples database will then return sample results at step 235, if any, to the licensing server, made available at step 237 to the licensee through the licensee station via the web interface to the licensing server.

The licensee may, at step 240, select articles of content from the content results for submission in a license request through the licensee station via the web interface to the licensing server. The licensing server then examines the request at step 245, optionally in conjunction with the licensor via the licensor station, and returns an answer at step 250 to the licensee via the web interface to the licensing server, which may be a grant or denial of a license, in whole or in part.

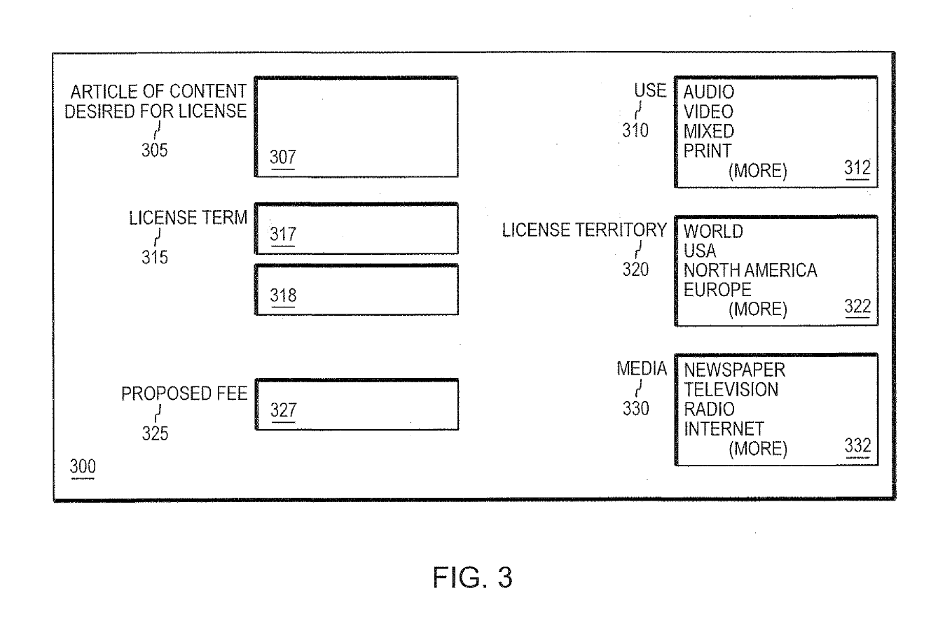

FIG. 3 is a block diagram illustrating a screenshot of a License Request Form (LRF) 300 that may be completed by a licensee (e.g., licensee 110 of FIG. 1) for submitting a license request (e.g., step 240 of FIG. 2) to a licensing system (e.g., licensing system 100 of FIG. 1). The LRF 300 defines elements of the license that the licensee seeks and may include identifying articles of content desired for license 305 entered in a text box 307, defining a specific type of usage of the identified content 310 selected from a list 312, a term of the license 315 entered by start date 317 and end date 318, a territory of the license 320 selected from a list 322, a proposed fee 325 for the license entered in a text box 327, and a media usage of the license 330 selected from a list 332.

If a licensor (e.g., licensor 120 of FIG. 1) set default parameters (e.g., step 215 of FIG. 2) for those articles of content identified 305 in the LRF 300, the licensing system automatically may return its answer regarding granting a license. Depending on whether the licensee's terms submitted in the LRF 300 were within the default parameters set by the licensor, this answer (e.g., step 250 of FIG. 2) may be an outright rejection of the license request in the LRF 300, or a conditional grant of a license under the terms of the LRF 300, identifying a quote price for the desired license.

If the terms of the LRF 300 do not meet the default parameters, or if the licensor did not set default parameters for those articles of content identified 305 so that the terms of the LRF 300 are to be evaluated manually, the licensee may be notified that the LRF 300 is under consideration and that the licensor has been notified of the request. The licensor immediately may reject the license request in the LRF 300 according to default parameters, if any, or following a manual evaluation. The licensing system also may generate custom responses to the licensee proposing revision of terms in the LRF 300.

Returning to FIG. 2, this may lead to numerous rounds of communication and negotiation at step 255 between the licensee, through the licensee station via the web interface, and the licensing server. Optionally, negotiation may be performed with the licensor at step 257 through the licensing server to the licensor station via the web interface, such as when the licensor does not submit default parameters at step 215. If negotiations are performed between the licensee and the licensing server via the web interface, the licensing server may grant a license at step 260 according to the default parameters submitted at step 210 by the licensor. If negotiations are performed with the licensor, the licensor may grant the license at step 262 via the licensing server.

After grant of the license, the licensee may tender payment at step 265 in fee for the license to the licensing server via the web interface, with the licensor receiving payment at step 267 from the licensing server. Optionally, the licensee may tender payment directly to the licensor. The licensing server then may retrieve the licensed content from the content database at step 270 and deliver the content to the licensee at step 275 through the licensee station via the web interface. Delivery may be tracked by the system by acquiring information from shippers (e.g., Federal Express (FedEx) and United Parcel Service (UPS)).

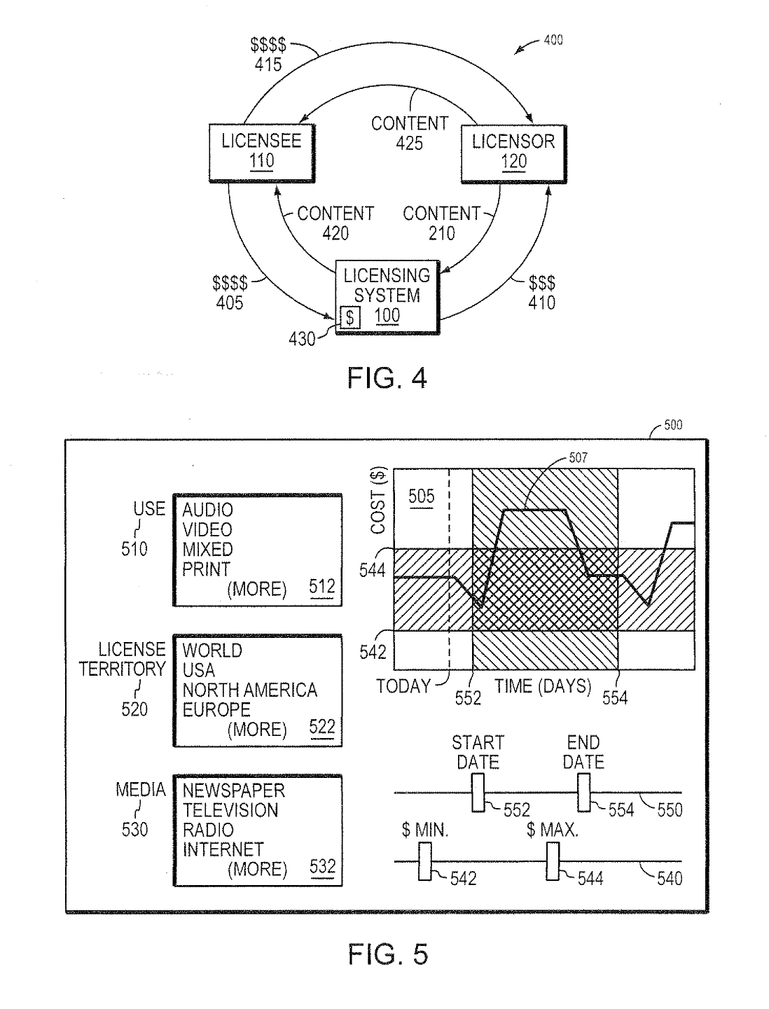

FIG. 4 is a diagram illustrating the flow of content and license fees between a licensing system 100, a licensee 110 and a licensor 120. The licensee 110 may make payment 405 to the system 100 for distribution 410 to the licensor 120 or directly 415 to the licensor 120. Payments 405, 410, 415 may be made by both offline (e.g., check, credit card, cash and wire transfer) and online (e.g., credit card, PayPal^{SM}, and Google Checkout^{SM}) methods. Following payment, the licensed content may be delivered to the licensee 110 automatically by the system 420 or via the licensor directly 425. Delivery may be made by online or traditional methods. Further, the system 100 may charge a fee for its use by licensees and licensors, such as a portion 430 of the licensing fee 405 paid by the licensee 110 for distribution to the licensor 120, or a membership fee, transaction fee, listing fee, time-based fee, maintenance fee, al a carte usage fee, or barter fee, or the licensing system may be advertising-supported, or any combination of the above.

Referring back to FIG. 1, usage of licensed content may be tracked by the licensing server 104 using external resources 108 such as movie listings databases, Nielsen Soundscan^{SM}, Nielsen Broadcast Data Systems^{SM} and print trade monitoring. Such usage may be confirmed by licensees 110 and relayed by the system 100 to licensors 120. Licensees 110 also may be required to submit accountings of specific uses to the licensing server 104 or licensors 120. The licensing server 104 also may track royalties based upon these usages and the terms of the license. The licensing server 104 may send payment reminders to licensees 110 when royalty payments are due, and default notices in the event of late or missed payments.

Other post-license services provided by the licensing server 104 include reporting to licensees 110 and licensors 120, including aggregated and individualized reports, tracking each transaction throughout the entire process including royalty, license and usage, reminders regarding license expiration and option periods, and dispute resolution, such as a mediation service agreed to as a term of the license which may utilized system records as evidence in any such dispute.

In the event that the licensor 120 is a number of individual content rights holders (e.g., content owners, artists, publishers, writers, mechanical master owners, performers), the system 100 allows communication among the parties. For example, rights holders can notify other rights holders of their needs and decisions regarding approvals and disapprovals regarding a license request. Other communications can include approval, rejection, request for greater detail, addition of specific term(s), and counteroffers. Communications among the parties, including the licensor 120 (whether an individual or a collective group) and the licensee 110, can be made “inside the system” (i.e., through a messaging system accessible through the user interface, such as electronic mail, instant message, or forum) or “outside the system” (i.e., via electronic mail, telephone, or other traditional means of communication), as desired by the parties and supported by the system 100. Communications made “in the system” may be logged in real time by the licensing server 104, including actions by all rights holders for review by other rights holders, by having these elements coordinated via the interface. This will be particularly helpful during negotiations involving multiple rights holders (e.g., music licensing) to achieve a final result more expeditiously.

Further, each rights holder (i.e., licensor 120) may submit a rights value for his share of the rights identified in the LRF. This information may be made available to the licensee 110 in response to the LRF if the rights holders so desire. Further, rights holders may be notified that one or more rights holders have either failed to reply to or have rejected the license request. This allows rights holders to intervene in the request if they are of strong opinion regarding whether the license request should be granted or denied. Similarly, such communications may be used in advance of license requests to encourage or discourage licensing under certain conditions. These communications between rights holders may be stored by the system and may include email, telephone (e.g., Voice over Internet Protocol (VoIP) and Public Switched Telephone Network (PSTN)), Wiki, weblog or instant message.

FIG. 5 is a block diagram illustrating a screenshot 500 of an analysis page enabling licensors and licensees to determine where their respective default parameters and requests for licensing fall within the market. Over time, the system 100 may monitor costs associated with the licensing of particular rights, whether those costs are determined outright by the licensor or after negotiation between the licensor and the licensee. Using this data, the system 100 may provide a licensing market trend 505, indicating average parameters for licensing, such as cost 507. The information provided by this data may allow extrapolation to the cost based on past history of similar content for similar uses 510, territories 520 and media 530. This allows licensors (such as rights holders) and licensees to determine where their respective default parameters and requests for licensing fall within the market for particular types of content and particular uses of that content. For example, a licensee could select desired uses 510, territories 520 and media 530 from their respective lists and text boxes 512, 522, 532. Further, using sliders 540, 550, the licensee could select a start date 552 and an end date 554 as well as a minimum price 542 and maximum price 544 for the desired license. The licensee could then adjust the sliders 540, 550 to determine what affect the adjustment has on where the licensee's offer falls according to an average for the market. Similarly, a licensor could determine what could be earned from potentially licensing particular material according to these market averages.

While this invention has been particularly shown and described with references to example embodiments thereof, it will be understood by those skilled in the art that various changes in form and details may be made therein without departing from the scope of the invention encompassed by the appended claims. Standard methods of sign in, security, authentication, reporting & content delivery may be utilized by the system. Further, the terms “license,” “licensee” and “licensor” are not be limited to only the process and parties involved in licensing content, but also refer the process and parties involved in other commercial exploitation of content: buyers and sellers in purchasing, renters and rentees in renting, and any parties procuring content by any means.

What is claimed is:

1. A computer-implemented method of transferring and processing data to support content clearance and licensing, the method comprising:
searching a database for content from providers relating to a search request;
returning search results identifying content relating to the search request;
selecting content for licensing;
submitting a request for license for the selected content;
examining the request for license; and
selectively approving or denying the request in whole or in part.

2. The method of claim 1 wherein the request for license is examined automatically and is selectively approved or denied according to default parameters established by the providers of the requested content.

3. The method of claim 1 wherein the request for license is examined manually by the providers of the requested content.

4. The method of claim 1 further comprising:
tracking a status of each request for license.

5. The method of claim 1 further comprising:
utilizing content samples in selecting content.

6. The method of claim 1 further comprising:
generating a license for approved requests; and
executing the license electronically.

7. The method of claim 1 further comprising:
providing resolution processes for license disputes.

8. The method of claim 1 further comprising:
delivering content of approved requests electronically.

9. The method of claim 1 further comprising:
collecting license fees on behalf of providers;
distributing the collected license fees according to the provider; and
tracking license fees collected and distributed.

10. The method of claim 1 further comprising:
storing information relating to past content clearance and licensing; and
providing market trend information based on the stored information including average parameters for licensing.

11. The method of claim 1 further comprising:
supporting internal communications.

12. The method of claim 1 further comprising:
supporting external communications.

13. A computer system for transferring and processing data to support content clearance and licensing, the system comprising:
a content database configured to store content submitted by providers;
a user interface configured to select content for licensing and configured to submit a request for license for the selected content; and
a processor configured to search the database for content relating to a search request, return search results identifying content relating to the search request, and examine the request for license and selectively approve or deny the request in whole or in part.

14. The apparatus of claim 13 wherein the processor automatically examines the request for license and selectively approves or denies the request for license according to default parameters established by the providers of the requested content.

15. The apparatus of claim 13 wherein the providers of the content requested for license manually examine the request for license and selectively approve or deny the request in whole or in part.

16. The apparatus of claim 13 wherein the processor further is configured to track a status of each request for license.

17. The apparatus of claim 13 further comprising:
a samples database configured to store content samples;
wherein the user interface further is configured to provide access to content samples for selecting content for licensing.

18. The apparatus of claim 13 wherein the processor further is configured to generate a license for approved requests and execute the license electronically.

19. The apparatus of claim 13 wherein the processor further is configured to provide resolution processes for license disputes.

20. The apparatus of claim 13 wherein the processor further is configured to deliver content of approved requests electronically.

21. The apparatus of claim 13 wherein the processor further is configured to collect license fees on behalf of providers, distribute the collected license fees according to the providers, and track license fees collected and distributed.

22. The apparatus of claim 13 further comprising:
a database configured to store information relating to past content clearance and licensing;
wherein the processor further is configured to provide market trend information based on the stored information.

23. The apparatus of claim 13 wherein the processor further is configured to support communications made internal through the user interface.

24. The apparatus of claim 13 wherein the processor further is configured to support communications made external to the user interface.

25. A computer system for transferring and processing data to support content clearance and licensing, the system comprising:
a database configured to store content;
means for selecting content for licensing and submitting a request for license for the selected content; and
means for searching the database for content relating to a search request, returning search results identifying content relating to the search request, examining the request for license, and selectively approving or denying the request in whole or in part.
